(19) United States
(12) Patent Application Publication
(10) Pub. No.: US 2010/0243917 A1
(43) Pub. Date: Sep. 30, 2010

(54) Method of improving probability of Knowing through which slit in a double slit system a particle or photon passes while still forming an interference pattern

(76) Inventor: James D. Welch, Omaha, NE (US)

Correspondence Address: JAMES D. WELCH, 10328 PINEHURST AVE., OMAHA, NE, 68124, US

(21) Appl. No.: 12/387,450

(22) Filed: May 4, 2009

Related U.S. Application Data
(60) Provisional application No. 61/211,514, filed on Mar. 31, 2009.

(51) Int. Cl. G01N 21/64; G01B 9/02; G01N 21/00

(52) U.S. Cl. 250/483.1; 356/521; 250/473.1

(57) ABSTRACT

A method of applying a double slit system to the end that both knowledge of an interference pattern formed on a screen located at one distance from the slits, and knowledge of improved probability as to which slit a particular particle or photon passed in the act of forming said interference pattern on that screen, wherein the method uses a remormalization interference pattern preliminarily provided on a screen located at a different distance from the slits, as a reference.

This Application Claims Benefit of 61/211,514 Filed Mar. 31, 2009.

### TECHNICAL FIELD

The present invention relates to the problem of improving probability of determining through which slit of a double slit system a particle or photon passes when forming an interference pattern on a first screen, and more specifically to a method of applying said double slit system to the end that both knowledge of an interference pattern formed on a second screen, and improved probability of knowing through which slit a particular particle or photon passed in the act of forming said interference pattern on said second screen, said method using the interference pattern formed on said first screen as a reference.

### BACKGROUND

Ever since passing a Maple requiring mathematics intensive course in Quantum Mechanics a decade+ ago:
(then stepping back and wondering - - - “what the hell was that?” - - - and then sitting through two advanced quantum courses in which I became “boggled by Bell”, and then later listening to Prof. Feynman's California and New Zealand lectures years ago, in which he said that no-one then knew how to determine which Slit of a Double Slit system a Particle or Photon passes while still securing an Interference Pattern (IP) - - - but maybe someday someone will figure it out) - - -
   I've been pondering the situation. This has led to various ideas being submitted to the USPTO to secure publication of my ideas. For instance, put the Double Slit system in a Bubble or Cloud Chamber or the like, and watch ions travel therethrough, or detect particles which reflect from the Screen on which they form an Interference Pattern, (see Published Application US 2005/0168748). So far however, my proposals have been responded to as being, at best, extremely difficult to actually practice so that results would be suspect. A common objection has been that monitoring the photon or particle in any way what-so-ever affects the momentum thereof, which in turn adversely affects the formation of the Interference Pattern.

Recently, while watching Kenyon University's Prof. Schumacher's Teaching Co. videos, I could not help but think more about the problem. I also recalled how Prof. Feynman beneficially used a “renormalization” procedure in developing Quantum Electrodynamics (QED). That has led to my conceiving a “back door” approach to the Double Slit problem. That is, knowledge of which Slit a particle or photon passes might be determinable - - - after - - - it contributes to formation of an Interference Pattern. This does not allow simultaneously having an Interference Pattern form and knowing through which Slit a particle or photon passed at the same instant in time, (but then no approach could do that as it takes time for a particle that passes through a Slit to reach a Screen), but rather allows improving the probability of knowing, later in time, which Slit the particle or photon passed after it contributed to the formation of the Interference Pattern. In that regard it is unclear as to if defeats the Uncertainty Principal, but what is presented might provide a way to obtain more certain information thought to be unavailable, as a matter of physical laws.

Continuing, better insight to the problem is realized by noting that it is known that when a beam of photons is caused to flow from a source located to one side of a barrier which has two closely situated slits therein, then an interference pattern can form and be observed on a screen at some distance beyond said barrier. This is true unless one attempts to determine which slit a photon passes through. If one attempts to monitor which slit a photon passes through, it is found that the interference pattern is altered to an extent directly related to success attained in determining through which slit a specific photon passed. Typically any attempt to determine which slit a photon passes through completely destroys the interference pattern. The same situation is observed when the flow of photons is replaced with a flow of electrons or other particles. In summary of this concept it is noted that it is generally agreed that it is impossible to determine both momentum and position of a particle under Heisenberg's Uncertainty Principal. In the context of a Double Slit system, this translates to saying that it is possible to accurately determine the momentum of a photon or particle approaching a Double Slit arrangement, hence it is impossible to know its exact position. Alternatively, it is possible to measure the lateral momentum of a photon or electron that passed through a Slit by monitoring where the photon or particle impinges on a Screen on which an Interference Pattern forms, but that any success in monitoring through which Slit it passes then becomes impossible. This means that the best probability known about which Slit a photon or particle passes is known only on a 50/50 basis. That is, it is generally accepted that the best one can say is that the photon or particle might have gone through one Slit or it might have gone through the other.

It is also recited that for moving particles, the DeBroglie wavelength thereof is given by dividing Plank's Constant by momentum:

Wavelength=h/p;

where h is Plank's Constant 6.626×10⁻³⁴ J-sec, and “p” is momentum. Also for reference, the rest mass of an electron is 9.11×10-31 Kg, and the mass of a Proton is about 1800 times as large. Further for a Double Slit arrangement, the Interference Pattern is characterized by:

H×Sin(θ)=#×wavelength; and

as Sin(θ) is approximately Z/X, the position “Z” on a Screen where a photon or particle impinges after passing through Double Slits which are Spaced apart by “H”, and at which is present a peak intensity, is approximately:

$$Z = \frac{\# \times Wavelength \times X}{H} ;$$

where “X” is the distance of the Screen from said Double Slits, and where “Z” is the distance from the perpendicular intersection of the Screen by a line taken from the mid-point between the Double Slits which is perpendicular to the Plane of said Double Slits, and # is an Integer.

It is also noted that to cause a charged particle to move toward and through Double Slits, an Electric Field is generally applied.

To give some insight to realistic numbers, for a Slit Spacing of 10⁻⁷ M, an Interference Pattern of about 10⁻⁴ M in width is formed at a Screen located a distance (“X” or “Y” in FIGS. 1 and 2) of 2×10⁻² M away. This means h/mv=5×10⁻¹⁰. So, Velocity=(6.626×10⁻³⁴ J-sec)/((9.11×10⁻³¹ Kg)*(5×10⁻10))=1.37×10⁹ meters/sec. If the Slit Spacing is increased to 10⁻⁵ M this reduces to 1.37×10⁷ meters/sec. And if a Proton is used which has a Mass of about 1.8×10³ that of the Electron, the velocity drops to 7.61×10³ meters/sec.

In conclusion of this Section of this Specification it is stated that the present invention provides an approach to arriving at better than a 50/50 probability of knowing through which Slit of a Double Slit System a photon or particle, which contributed to formation of an Interference Pattern, passed.

### DISCLOSURE OF THE INVENTION

The present invention is a method of applying a double slit system to the end of securing improved knowledge of both an interference pattern, and through which silt thereof a particle or photon passes in the act of forming said interference pattern. Said method comprises:

a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
   said system being arranged to allow said source to project a particle or photon at said barrier having two slits therein, pass through a slit and contribute to formation of an interference pattern at the first screen.

Said method further comprises:

b) by causing a multiplicity of particles or photons from said source thereon to pass through one or the other of the slits in said barrier having two slits therein, developing a renormalization interference pattern at the location of the first screen, and securing said pattern;

c) causing said second screen to be located at a distance (Y) from said barrier having two slits therein, wherein (Y) is less than (X);

d) causing a particle or photon to pass through one or the other of said slits in said barrier having two slits therein, and impinge on said second screen;

e) noting the location where upon said second screen said particle in step d impinges, and projecting lines from each slit through said location on said second screen and determining where said lines impinge on the fixed the renormalization interference pattern developed in step b; and

concluding that the projection line consistent with the greatest probability corresponding to said renormalization interference pattern on the first screen indicates through which slit the particle or photon passed to a better than 50/50 certainty.

Said method can further comprise, while improving the probability of which slit through which a particle or photon passes as in step e, causing a sequential multiplicity of particles to impinge on said second screen, one by one, to the end that an interference pattern is achieved upon said second screen.

While not preferred, a modified method of applying a double slit system to the end of securing knowledge of both an interference pattern, and through which silt thereof a particle or photon passes in the act of forming said interference pattern, comprises:

a) providing a double slit system comprising:
a source of particles or photons capable of providing a single particle or photon at a time;
a barrier having two slits therein;
a second screen located at some distance (Y) from said barrier having two slits therein;
a first screen which can be located at a distance (X) from said barrier having two slits therein, wherein (X) is greater than (Y);
   said system being arranged to allow said source to project a particle or photon at said barrier having two slits therein, pass through a slit and contribute to formation of an interference pattern at the second screen.

Said method further comprises:

b) by causing a multiplicity of particles or photons from said source thereon to pass through one or the other of the slits in said barrier having two slits therein, developing a renormalization interference pattern at the location of the second screen, and securing information which describes said pattern;

c) removing said second screen from said position (Y), and causing said first screen to be located at a distance (X) from said barrier having two slits therein, wherein (X) is greater than (Y);

d) causing a particle or photon to pass through one or the other of said slits in said barrier having two slits therein, and impinge on said first screen;

e) noting the location where upon said first screen said particle in step d impinges, and projecting lines from each slit through said location on said first screen and determining where said lines impinge on the fixed the renormalization interference pattern developed in step b; and

concluding that the projection line consistent with the greatest probability corresponding to said renormalization interference pattern on the second screen indicates through which slit the particle or photon passed to a better than 50/50 certainty.

Again, the method can include, while improving the probability of knowing through which slit through which a particle or photon passes, causing a sequential multiplicity of particles to impinge on said first screen, one by one, to the end that an interference pattern is achieved upon said first screen.

It is note that the Renormalization Interference Pattern identified above corresponds to an Intensity and that squaring and normalizing it provides an indication of probability.

It is noted that, while not limiting, the photons or particles can be selected from the group consisting of:
photons;
electrons;
positrons;
protons;
neutrons;
atoms
ionized atoms; and
molecules.

It is also noted that a source of single particles can comprise fluorescense or phosphoresence emitting materials. For instance, such a phosphoresing material could be utilized to provide custom single particles, and their paths monitored. If a small enough phospherousing particle is available the present methodology can then directly monitor a photon or particle position while providing conditions that let Interference Patterns form. However, more basically, after pattern formation, one pattern is applied to allow better determining through which Slit a particle passed to have formed a second Interference Pattern, in order to be consistent with the first formed pattern.

It is also noted that steps other than those involving providing the system can be practiced under the control of a computer. That is steps involving:
causing a multiplicity of particles or photons from said source thereon to pass through one or the other of the sits in said barrier having two slits therein,
developing an interference pattern at the location of the first/second screen, and securing information which describes said pattern; and
causing a particle or photon to pass through one or the other of said slits in said barrier having two slits therein, and impinge on said second/first screen and noting the location where upon said second/first screen said particle impinges, and
projecting lines from each slit through said location on said second/first screen and determining which line is consistent with the information fixed regarding the interference pattern developed earlier; and
concluding that the line consistent with the higher probability indicates through which slit the particle or photon passed;
   can be automated and fully controlled by a computer.

Further, as recently suggested to me, “calculation” could be applied as an approach to forming a “Renormalization” Interference Pattern in the steps b above. This can work as the effects of interence are well known and can be calculated. However, to compensate any effects in the specific system applied, it might be best to actually develop the renormalization pattern.

This can further involve a scaling up of the dimensions of an achieved Interference Patterns to aid with analysis.

Finally, it is specifically pointed out that the present method does not require a photon or particle interact with anything other than the Screen on which an Interference Pattern is formed. This avoids the problem of altering the momentum of a photon or particle as part of the method, (eg. monitoring a particle which reflects from a Screen on which is formed an Interference Pattern via a second Screen).

The present invention will be better understood by reference to the Detailed Description Section of this Specification in combination with the Drawings.

### BRIEF DESCRIPTION OF THE DRAWINGS

FIGS. 1 and 2 demonstrate double slit systems applied in the present Invention methodology.

FIG. 3 shows how expected “channels” of Interference Pattern location v. distance from silts can be developed experimentally by developing Interference Patterns at a plurality of screen locations.

### DETAILED DESCRIPTION

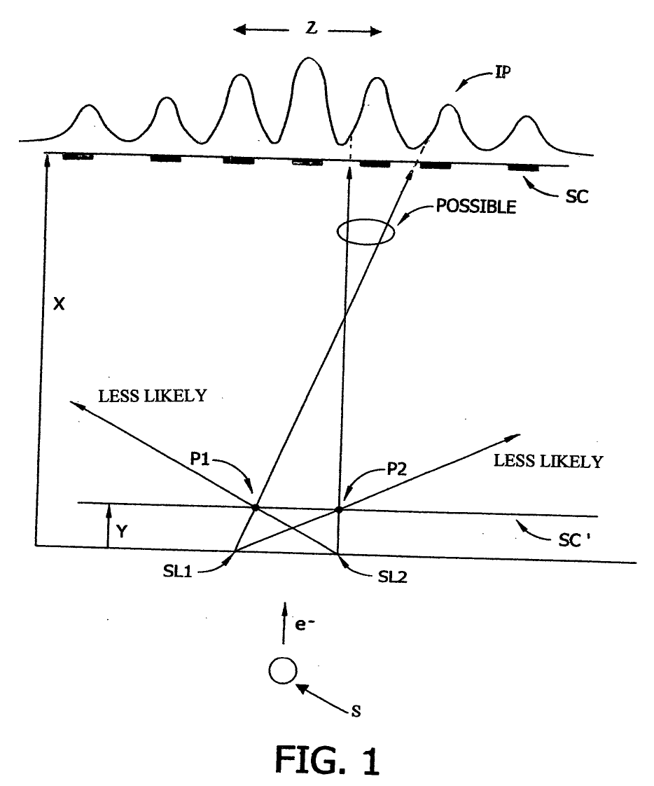

Turning now to FIG. 1, there is shown a well known experimental system of two Slits (SL1) and (SL2), with a Source (S) provided particle electron or photon or molecule etc. (e⁻) approaching. Also shown are two screens (SC) and (SC′) at distances (X) and (Y), (where Y is less than (X)), respectively. Screen (SC) is indicated as having had an Interference Pattern (IP) formed thereupon by causing a multiplicity of particles or photons to impinge thereupon, preferably one at a time, when the Second Screen (SC′) is not present. While it is generally accepted that the particle or photon passed through one of the Slits (SL1) (SL2), it is known that any attempt to monitor which Slit (SL1) (SL2) it passed, causes the Interference Pattern (IP) to disappear. In view of the Uncertainty Principal it is generally believed that it is impossible to know both which slit a particle or photon passed, and still see an Interference Pattern (IP) form.

Now, with the indicated Interference Pattern (IP) secured AND LEFT IN PLACE at the location (X) of Screen (SC), a Second Screen (SC′), (which can be the First Screen moved), is entered which is closer to the Slits (SL1) (Sl2), but not so close as to block either Silt (SL1) (Sl2). Then particles or photons are caused to impinge thereupon one at a time, and impinge on the Second Screen (SC′). Now, knowing how the Double Slit system performed, (eg. the left in place formed Interference pattern (IP)), when the First Screen (SC) was placed distance “X” from the Slits (SL1) (SL2), and the positions of said Slits (SL1) (SL2), it is possible to project a line from each Slit (SL1) (SL2) through the point on the Second Screen (SC′) where the particle or photon impinged, and see where it would have impinged on the First Screen (SC) if the Second Screen (SC′) were absent. As FIG. 1 shows, it might be readily obvious that the particle or photon (P1) (P2) must have passed through one of the Slits (SL1) (SL2), as if it passed through the other Slit (SL1) (SL2) it would not have reached the First Screen (SC), at a location consistent with the Interference Pattern (IP) secured when said First Screen (SC), which was (X) away from the form the Slits (SL1) (SL2), were the Second Screen (SC′) absent. But, projections from the Slits (SL1) (SL2) to the First Screen (SC) Interference Pattern (IP) do provide a clear indication that one Slit would provide more probable results. Note it is not necessary that a projection land on the First Screen (SC) at a location corresponding to a peak of the Interferecne Pattern (IP). In fact, both projections identified as “Possible” associate with relatively low Intensities.

The present approach assumes a particle or photon's path to a Screen (SC) (SC′) is determined as soon as it emerges from one of the Slits (SL1) (SL2). That is, it is assumed that a straight line can be drawn from each of the Slits (SL1) (SL2) through a point of impingement on the Second Screen (SC′) to project where the particle of photon would have arrived at the position (X) away from the Slits (SL1) (SL2), had the Second Screen (SC2) not been present.

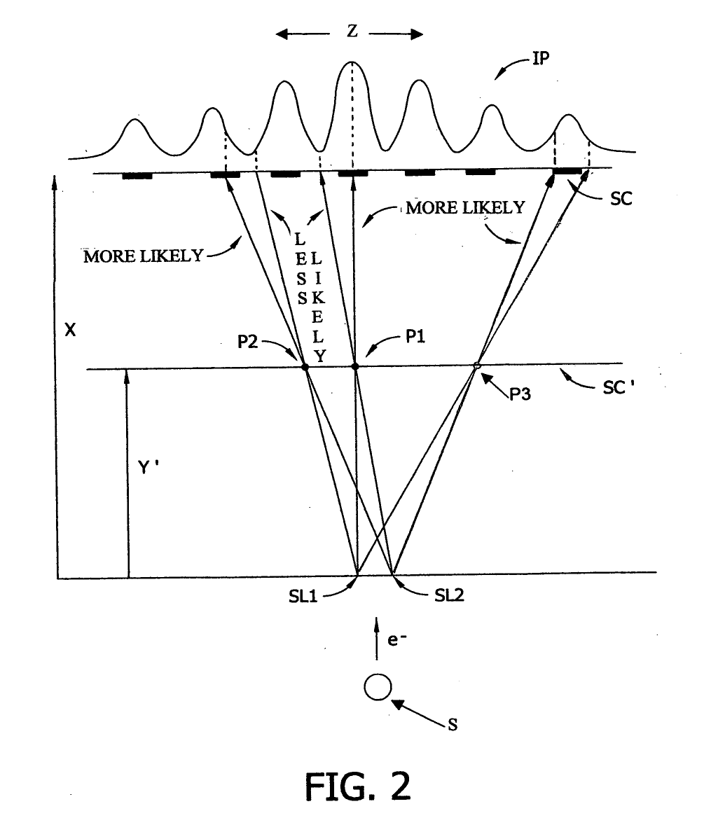

FIG. 2 shows a FIG. 1 scenario with the Slits (SL1) (SL2) situated more closely together and with the Second Screen (SC′) closer to the First Screen (SC) than is the case in FIG. 1. The example of FIG. 2 is less exaggerated, but note that it is still possible that the same present invention methodology will lead to a similar result, that being that a particle or photon impinging on the Second Screen (SC′) will project to a peak region of an Interference Pattern on the First Screen (SC), or a low probability region, depending through which Slit (SL1) (SL2) the particle or photon is assumed to have passed. Note that FIG. 2 demonstrates that a Particle (P1) impinged on the Second Screen (SC′), at a location for which projections form Slits (SL1) and (SL2) therethrough intercept the First Screen (SC), with the projection from the First Slit (SL1) approaching the Interference Pattern at a Peak of the Renormalization Interference pattern and with the projection from the Second Slit (Sl2) approaching the Interference Pattern at a Valley of the Renormalization Interference pattern. The method of the present invention provides that this shows a better than 50/50 probability that the photon or particle that was measured on the Second Screen (SL′) at point (P1), passed through the First Slit (SL1). (Note, to correspond to probability the Renormalization Interference Pattern (IP) on the First Screen (SC) the shown Intensity pattern would have to squared).

It is also disclosed that a probability as to which Slit a photon or particle passes can be developed by a procedure involving determining the intensity associated with how photons or particles impinge at each point on the First Screen (SC) during formation of the Interference Pattern (IP) thereon. Then, perhaps, divide all the intensities by that at the lowest valley such that the lowest valley shows an intensity of 1. Then when the Projections are made from the Slits (SL1) and (SL2) through a point on the Second Screen (SC′) to the First Screen (SC), one can determine what intensity corresponds to the location at which each Projection intersects the First Screen (SC). Say that the highest peak corresponds to an intensity of 100 and one Projection does indeed correspond to the Highest Peak, and the other Projection corresponds to the lowest Valley, one can determine the 100 out of 101 times the First Projection is valid. This is essentially, although not quite, 100%. The Third Particle (P3) in FIG. 2 demonstrates this for much closer intensities. Say the Intensities are associated with a more probable 10 and a less probable 2. The probability that the Slit (SL2) associated with the 10 is the one the photon or particle that impinged on the Second Screen (SC′) through which the projections pass, is 10/(12)=83%, while the probability that it passed through the other Slit (S11) is only 17%. That is much better than 50/50. Even for the case where the projections correspond to intensities of 5 and 4, the probability that the photon or particle passed through the Slit associated with the intensity of 5 is the one the photon or particle that impinged on the Second Screen (SC′) through which the projections pass, is 5/9=55%, which is again better that 50%, which the best possible result before application of the present invention. The benefits provided by the present invention will vary with each photon or partical, depending on where it arrives at the Second Screen (SC′), but in all cases where said projections lead to determining different intensities on the First Screen (SC) Renormalization Curve, it will result that one of the Slits will be shown as the more probable one.

While the present method does not determine 100% confidence as to which Slit a photon or particle passes, it does provide a potentially very high probability that, (in the case of some particles, depending on where projections from the Slits through through the location of a photon or particle impingement on the Second Screen, impinge on the Renormalization Interference Pattern Curve), knowledge of which Slit the photon or particle passed can be determined. This is coupled with 100% measured knowledge of where on the Second Screen the photon or particle impinged. In that light some inroad to overcoming the Uncertianty Principal might be achieved. It can, however, be argued that since some chance remains that the photon or particle did not pass through the Slit associated with the high probability, that an Uncertianty remains as to which Slit the photon or particle which impinges on the Second Screen passed, thus leaving the Uncertianty Principal intact. As the Uncertianty Principal seems to be deeply ingrained in the fabric of Physics, this is perhaps a good result.

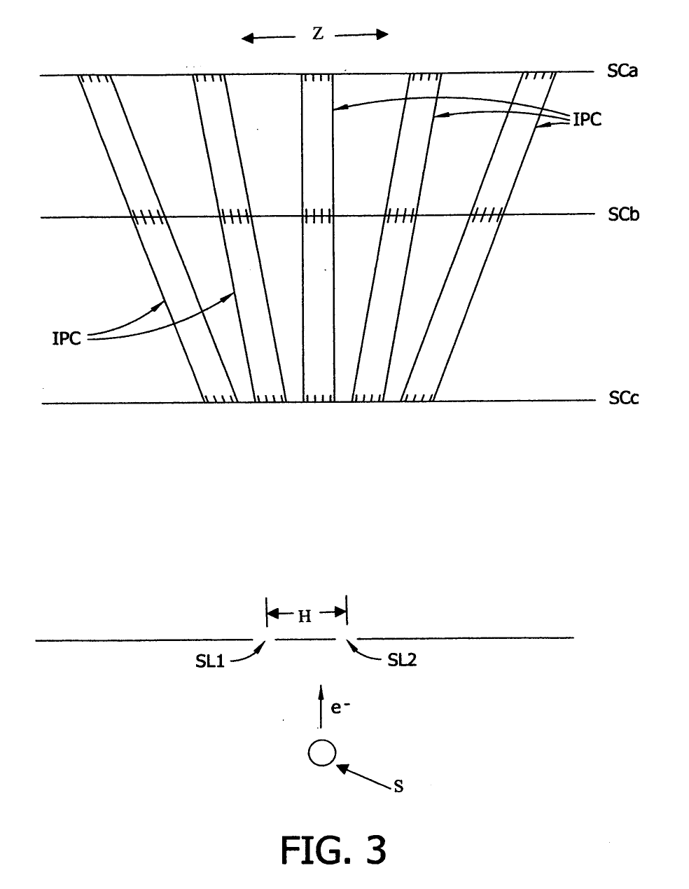

Note, it is the Interference Pattern formed on the Second Screen (SC′), for which improved probability will be known as regards which Slit (SL1) (SL2) each particle or photon passed. The present invention method is based in a believe that presence or absence of the Second Screen (SC′) should have no effect on how what emerges from the two Slits (SL1) (SL2) directs a particle or photon. That is similar to saying that moving the First Screen (SC) closer or further away from the two Slits (SL1) (SL2) has no effect other than to expand or contract the Interference Pattern laterally. However, should there be an effect other than lateral expansion of the Interference Pattern when the First Screen (SC) is moved from a distance (X) away from the Slits (SL1) (Sl2), closer to the Slits (SL1) (SL2), this can be compensated by obtaining a plurality/multiplicity of experimental Interference Patterns (IP) at a plurality/multiplicity of distances between the distance (X) and the Slits (SL1) (Sl2). From the results such an effort one can construct channels in three-dimensional space in which a particle or photon can arrive, and these can be used to enable compensation for any effect of the presence of the Second Screen (SC′). Then one can proceed as described above, with the Screen at (Y). FIG. 3 shows how expected “Channels” (IPC) of Interference Pattern location v. distance from Slits (SL1) (SL2) can be developed experimentally by developing Interference Patterns at a plurality of Screen (SCa) (SCb) (SCc) etc. locations. However, in view of the equation:

$$Z = \frac{\# \times Wavelength \times X}{H} ;$$

which was disclosed in the Background Section, it is believed compensation of such an effect will not be necessary. Note that the lateral spread (Z) of an Interference Pattern is directly proportional to “X”, (and inversely proportional to (H)). Adjustment of parameters (X) (Y) (H) and Wavelength will determine the resulting Interference Pattern dimensions on both Screens (SC) and (SC′).

It is further noted that the method can be practiced by obtaining and fixing an Interference Pattern on a Screen, (eg. (SC′)), located a distance (Y) from the Silts (SL1) (SL2), and the proceed much as described above, with the difference being that said Screen (SC′) is then removed and a single particle or photon is then caused to imping on a Screen, (eg. (SC)), which is further away; (eg. (X)), from the Slits (SL21) (SL2), and then project lines from each Slit (SL1) (Sl2) through said position on said Screen (SC) where said single particle or photon was caused to impinge. It can again occur that the projected line from one Slit passes through the fixed in place Interference Pattern on the Screen (SC′) nearer the Slits (SL1) (SL2) with a higher probability than does the other.

Finally, it is noted that the Interference Pattern (IP) is actually situated in the plane of the First Screen (SC) and the Drawings show Intensity Curves. Squaring the Amplitudes thereof results in a typical Probability Pattern, which appears even more pronounced. For instance, in the case where intensities were 4 and 5, the probability based on the squares is 25/(25+16) is 61%, rather than 55%. Further, the Drawings are not to scale. An acutal Double Slit System would have the Screens (SC (SC′) positioned further from the Slits (SL1) (SL2).

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

I claim:

1. A method of applying a double slit system to the end of securing improved knowledge of both an interference pattern, and through which silt thereof a particle or photon passes in the act of forming said interference pattern, comprising the steps of:
a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
said system being arranged to allow said source to project a particle or photon at said barrier having two slits therein, pass through a slit and contribute to formation of an interference pattern at the first screen;
b) by causing a multiplicity of particles or photons from said source thereon to pass through one or the other of the slits in said barrier having two slits therein, developing a renormalization interference pattern at the location of the first screen, and securing said pattern;
c) causing said second screen to be located at a distance (Y) from said barrier having two slits therein, wherein (Y) is less than (X);
d) causing a particle or photon to pass through one or the other of said slits in said barrier having two slits therein, and impinge on said second screen;
e) noting the location where upon said second screen said particle in step d impinges, and projecting lines from each slit through said location on said second screen and determining where said lines impinge on the fixed the renormalization interference pattern developed in step b; and
concluding that the projection line consistent with the greatest probability corresponding to said renormalization interference pattern on the first screen indicates through which slit the particle or photon passed to a better than 50/50 certainty.

2. A method as in claim 1, wherein whole determining which slit through which a particle or photon passes as in step e, causing a multiplicity of particles to impinge on said second screen, one by one, to the end that an interference pattern is achieved upon said second screen.

3. A method of applying a double slit system to the end of securing improved knowledge of both an interference pattern, and through which silt thereof a particle or photon passes in the act of forming said interference pattern, comprising the steps of:
a) providing a double slit system comprising:
a source of particles or photons capable of providing a single particle or photon at a time;
a barrier having two slits therein;
a second screen located at some distance (Y) from said barrier having two slits therein;
a first screen which can be located at a distance (X) from said barrier having two slits therein, wherein (X) is greater than (Y);
said system being arranged to allow said source to project a particle or photon at said barrier having two slits therein, pass through a slit and contribute to formation of an interference pattern at the second screen;
b) by causing a multiplicity of particles or photons from said source thereon to pass through one or the other of the slits in said barrier having two slits therein, developing an interference pattern at the location of the second screen, and securing information which describes said pattern;
c) removing said second screen from said position (Y), and causing said first screen to be located at a distance (X) from said barrier having two slits therein, wherein (X) is greater than (Y);
d) causing a particle or photon to pass through one or the other of said slits in said barrier having two slits therein, and impinge on said first screen;
e) noting the location where upon said first screen said particle in step d impinges, and projecting lines from each slit through said location on said first screen and determining where said lines impinge on the fixed the renormalization interference pattern developed in step b; and
concluding that the projection line consistent with the greatest probability corresponding to the remormalization interference pattern on the second screen indicates through which slit the particle or photon passed to a better than 50/50 certainty.

4. A method as in claim 1, wherein while determining which slit through which a particle or photon passes as in step e, causing a multiplicity of particles to impinge on said first screen, one by one, to the end that an interference pattern is achieved upon said first screen.

5. A method as in claim 1, in which the source of particles or photons provides a selection from the group consisting of:
photons;
electrons;
positrons;
protons;
neutrons;
atoms
ionized atoms;
molecules; and
phosphorescing particles.

6. A method as in claim 3, in which the source of particles or photons provides a selection from the group consisting of:
photons;
electrons;
positrons;
protons;
neutrons;
atoms
ionized atoms;
molecules; and
phosphorescing particles.

7. A method as in claim 1, wherein steps b, d and e are controlled by a computer.

8. A method as in claim 3, wherein steps b, d and e are controlled by a computer.

9. A method as in claim 1 in which a the source is a source of particles having the quality of being emitting of a detectable output selected from the group consisting of:
fluorescence; and
phosphorescence.

10. A method as in claim 3 in which a the source is a source of particles having the quality of being emitting of a detectable output selected from the group consisting of:
fluorescence; and
phosphorescence.

11. A method of applying a double slit system to the end of securing improved knowledge of both an interference pattern, and through which silt thereof a particle or photon passes in the act of forming said interference pattern, comprising the steps of:
a) providing a double slit system comprising:
a source of particles capable of providing a single particle at a time, said particles having the quality of being emitting of a detectable output selected from the group consisting of:
fluorescence; and
phosphorescence.
a barrier having two slits therein;
a screen located at some distance (X) from said barrier having two slits therein;
b) while detecting electromagnetism emitted by a particle, causing said particle to pass through one or the other of said slits in said barrier having two slits therein, and impinge on said screen to the end that it contributes to the formation of an interference pattern.
